(19) United States
(12) Patent Application Publication
(10) Pub. No.: US 2013/0088899 A1
(43) Pub. Date: Apr. 11, 2013

(54) MULTI-PHASE CONVERTER

(71) Applicant: Takeshi Iwata, Fukuoka (JP)

(72) Inventor: Takeshi Iwata, Fukuoka (JP)

(73) Assignee: RICOH COMPANY, LIMITED, Ohta-Ku, Tokyo (JP)

(21) Appl. No.: 13/704,768

(22) PCT Filed: Jun. 22, 2011
(86) PCT No.: PCT/JP2011/064860

§ 371 Date: Dec. 17, 2012

(30) Foreign Application Priority Data
Jun. 22, 2010 (JP) 2010-141160

(51) Int. Cl. H02M 7/08

(52) U.S. Cl. CPC H02M 7/08
USPC 363/70

(57) ABSTRACT

A multi-phase converter of one of the embodiments includes: a plurality of AC/DC converters which are connected in parallel to each other, wherein each of the plurality of AC/DC converters includes a power factor correction circuit and a DC/DC converter that is connected in series to the power factor correction circuit and that receives an output from the power factor correction circuit, and the power factor correction circuit includes an output voltage adjusting circuit that adjusts an output voltage from the power factor correction circuit.

### TECHNICAL FIELD

The present invention relates to a multi-phase converter including a plurality of AC/DC converters, each having a power factor correction circuit and a DC/DC converter which is connected in series to the power factor correction circuit and receives an output of the power factor correction circuit, connected in parallel to each other.

### BACKGROUND ART

In recent years, there is a demand for home appliances or office machines with low power consumption; and power supply apparatuses with high conversion efficiency are required in order to meet the demand. Among them, a switching power supply in which a power factor correction circuit (hereinafter, referred to as a PFC circuit) is connected in series to an LLC current resonant converter (hereinafter, referred to as an LLC) has been widely used as a power supply with a small size, high conversion efficiency, and low noise.

FIG. 1 is a diagram illustrating the structure of an AC/DC converter including a PFC circuit and an LLC current resonant converter according to the related art.

In the related art, a PFC circuit 20 is a boost-type converter and is controlled by a PFC controller IC 2 that is generally available on the market. Next, the control operation of the PFC controller IC 2 will be described. The PFC controller IC 2 turns on an n-channel MOSFET 4 so that energy is charged to a PFC coil 3 with a voltage waveform obtained by full-wave rectifying an AC voltage with a bridge diode 1. In addition, when the n-channel MOSFET 4 is turned off, the PFC controller IC 2 transmits the energy stored in the PFC coil 3 to an output smoothing capacitor 7 through a diode 5 and stores the energy in the output smoothing capacitor 7.

FIG. 2 is a diagram illustrating the operation of the PFC controller. FIG. 2 shows a case in which the PFC circuit 20 is operated in the critical mode. In FIG. 2, a signal VG is a control signal for the n-channel MOSFET 4.

For the ON/OFF timings of the control signal, the ON time is determined by an error (detected by an output voltage detecting circuit 6) between an output voltage and a set value, and an AC voltage value. The OFF time is the time until an inductor current becomes zero. An inductor current IL is measured by adding an auxiliary coil to the PFC coil 3. In the PFC circuit 20, the waveform of the AC voltage and the waveform of the average current have substantially the same phase. As a result, the power factor is high. In addition, in the PFC circuit 20, it is possible to maintain an output DC voltage to be constant, regardless of an input AC voltage. Therefore, the power supply is effective as a worldwide power supply.

Next, an LLC current resonant converter 30 according to the related art will be described. The LLC current resonant converter 30 is controlled by an LLC controller 8 that is generally available on the market. Next, the control operation of the LLC controller 8 will be described.

The LLC controller 8 alternately turns on/off an n-channel MOSFET 9 and an n-channel MOSFET 10 to change the polarity of the voltage from the PFC circuit 20; applies the voltage to the primary side of an isolation transformer 12; and transmits energy to the secondary side of the isolation transformer 12. An error between the output voltage V2 and a set value is detected by an error amplifier 16; and the output voltage V2 is fed back to the LLC controller 8 through a photocoupler 15. In The LLC controller 8, a frequency that turns on/off the n-channel MOSFET 9 and the n-channel MOSFET 10 changes in accordance with the error value and maintains the output voltage V2 at the set value.

In general, when the turn ratio of the primary and secondary windings of the isolation transformer 12 is n:m, the output voltage V2 is set so as to satisfy V2>V1/2×m/n (where V1 is an input voltage to the isolation transformer 12 (an output voltage from the PFC circuit 20)). Next, the setting of the output voltage V2 will be described with reference to FIG. 3.

FIG. 3 is a diagram illustrating the setting of the output voltage from the isolation transformer. In FIG. 3, a signal V4 is the voltage of a capacitor 11 for resonance. The voltage of the capacitor 11 for resonance is changed by a current resonance operation caused by the primary inductance of the isolation transformer 12 and the capacitance of the capacitor 11 for resonance. In the isolation transformer 12, when the voltages V3 and V4 of two ends of the primary side satisfy |V3−V4|>V1/2, energy moves from the primary excitation inductance to the secondary inductance of the isolation transformer 12. In this case, the current resonance caused by the primary inductance and the capacitor 11 for resonance is the resonance between a leakage inductance and the capacitor 11 for resonance, since the excitation inductance transmits energy to the secondary inductance. The leakage inductance is an inductance component that is included in the primary inductance of the isolation transformer 12, but is not necessary for the transmission of energy from the primary side to the secondary side.

The LLC current resonant converter 30 is referred to as an LLC current resonance type since the series resonance of the excitation inductance (L), the leakage inductance (L), and the capacitor (C) for resonance is used.

In addition, threshold levels with amplitudes W1 and W2 shown in FIG. 3 that are transmitted to the secondary side of the transformer satisfy V2>V1/2×m/n. When V2 V1/2×m/n is satisfied, only the current resonance between the leakage inductance and the capacitor 11 for resonance is obtained. However, since there is the time at which the condition |V3−V4|>V1/2 cannot be ensured, the secondary output current is not continuous. Therefore, when the polarity of the current is changed, the current rises rapidly.

As a result, the loss generated through output rectifying diodes 13 and 14 increases, which results in an increase in noise. In addition, when the switching frequency of a light load is high, it may be difficult to perform control.

For this reason, the output voltage V2 is used under the condition of V2>V1/2×m/n. When the output voltage V2 satisfies V2>V1/2×m/n, currents Id1 and Id2, flowing through the output rectifying diodes 13 and 14, each have a waveform close to the half-wave rectified waveform of the sine wave, and there is no inrush current. Therefore, power loss due to the output rectifying diodes 13 and 14 is reduced or noise is reduced.

As shown in FIG. 3, in the LLC controller 8, there is a dead time between the on and off control times of a signal HVG and a signal LVG. During a dead time period t1, since the voltage of the signal V3 is equal to the input voltage V1, the signal HVG is turned on and there is no switching loss of the signal HVG. In addition, during a dead time period t2 shown in FIG. 3, since the signal V3 is 0 V, the signal LVG is turned on and there is no switching loss of the signal LVG (referred to as a zero volt switching (ZVS) operation).

As described above, the combination of the PFC circuit 20 and the LLC current resonant converter 30 makes it possible to achieve a worldwide switching power supply that is capable of improving the power factor and has low loss (high efficiency) and low noise.

However, when high output power is obtained from the switching power supply including the PFC circuit 20 and the LLC current resonant converter 30, the size of the PFC coil 3 or the isolation transformer 12 increases. In order to solve the problem, a means is considered which increases the switching frequency and reduces the size of the PFC coil 3 or the isolation transformer 12. However, in this case, switching loss increases, which is not preferable.

As a means other than the means increasing the switching frequency, for example, there is a multi-phase DC/DC converter in which a plurality of DC/DC converters is connected in parallel to each other to increase power.

For example, Patent Literature 1 (Japanese Patent Application Laid-open No. 2007-116834) discloses a multi-phase DC/DC converter in which a plurality of DC/DC converters is connected in parallel to each other; the phases of the outputs of the DC/DC converters are shifted; and output currents are synthesized, thereby responding to a large amount of current and low noise. In addition, in the multi-phase DC/DC converter disclosed in Patent Literature 1 (Japanese Patent Application Laid-open No. 2007-116834), transformers or coils are dispersed to increase the mounting range. In this way, the total size of the multi-phase DC/DC converter is reduced. In the multi-phase DC/DC converter disclosed in Patent Literature 1 (Japanese Patent Application Laid-open No. 2007-116834), in particular, for a technique that improves the conversion efficiency of an apparatus in which a load is changed and there are a heavy load and a light load, provided is a circuit that selects the optimal number of DC/DC converters to be operated according to the size of a load or ambient temperature.

A general multi-phase DC/DC converter is a pulse width modulation (hereinafter, referred to as PWM) converter which adjusts a pulse width to respond to a change in load. Therefore, for example, even when there is a variation in the circuit impedance of each DC/DC converter, the variation is adjusted by each driving pulse width and the load is uniformly dispersed in each DC/DC converter.

When a pulse frequency modulation (hereinafter, referred to as PFM) DC/DC converter, such as the LLC current resonant converter 30, is configured so as to have multiple phases, the PFM system adjusts the switching frequency to respond to a change in load. Therefore, when a plurality of PFM converters is connected in parallel to each other and there is a variation in the circuit impedance or reactance of each PFM converter, it is necessary to make the switching frequencies different from each other in order to obtain a uniform output. In this case, it is difficult to maintain a phase difference to be constant and thus difficult to obtain multiple phases.

In order to solve the above-mentioned problems, Patent Literature 2 (Japanese Patent No. 4229177) discloses a multi-phase DC/DC converter which selects the order in which switching is performed on the basis of the difference between the output currents from a plurality of DC/DC converters. In the multi-phase DC/DC converter disclosed in Patent Literature 2 (Japanese Patent No. 4229177), the order of the DC/DC converters operated during a multi-phase operation is selected so that the difference between the output currents is reduced and the influence of an output variation is reduced. In this way, the multi-phase operation is achieved.

However, in the multi-phase DC/DC converter disclosed in Patent Literature 2 (Japanese Patent No. 4229177), the frequency of each DC/DC converter is synchronized with a clock signal (reference clock) and the frequency of each phase is not constant. Therefore, the OFF period is at least several times longer than the ON width. It is predicted that the time-averaged output power of a single phase is less than that of a single-phase DC/DC converter. Therefore, the effect of multiple phases is reduced.

The invention has been made in view of the above-mentioned problems and an object of the invention is to provide a multi-phase converter capable of maximizing its function without damaging the output power capacity of each LLC current resonant converter even when multiple phases are obtained.

### DISCLOSURE OF INVENTION

In order to achieve the object, the invention has the following structure.

A multi-phase converter of one of the embodiments includes: a plurality of AC/DC converters which are connected in parallel to each other, wherein each of the plurality of AC/DC converters includes a power factor correction circuit and a DC/DC converter that is connected in series to the power factor correction circuit and that receives an output from the power factor correction circuit, and the power factor correction circuit includes an output voltage adjusting circuit that adjusts an output voltage from the power factor correction circuit.

### BRIEF DESCRIPTION OF DRAWINGS

FIG. 1 is a diagram illustrating the structure of an AC/DC converter including a PFC circuit and an LLC current resonant converter according to the related art;

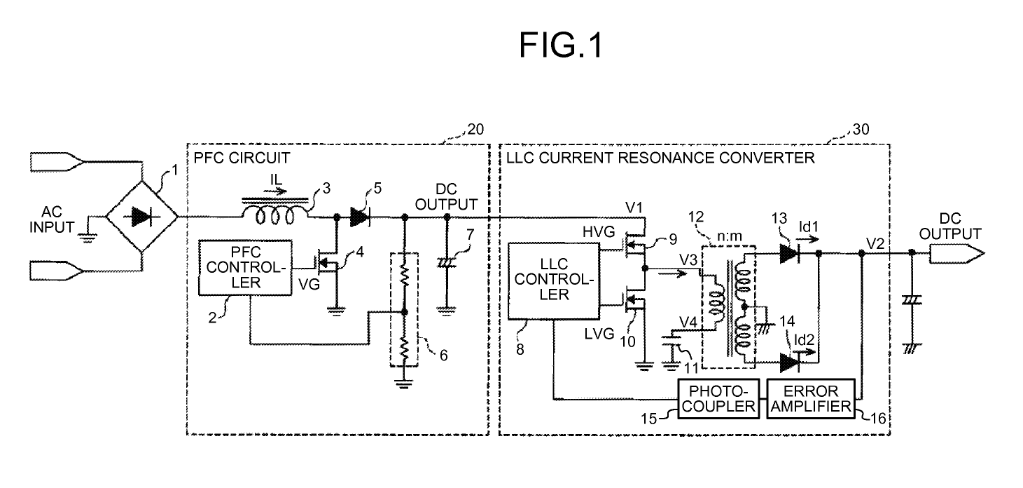

FIG. 2 is a diagram illustrating the operation of a PFC controller;

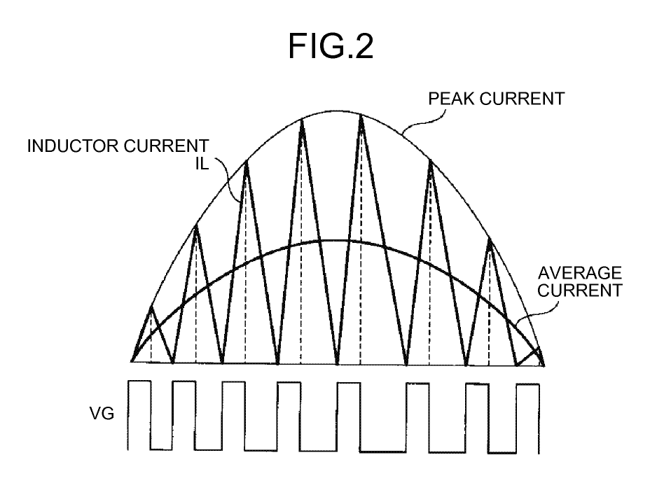

FIG. 3 is a diagram illustrating the setting of an output voltage from an isolation transformer;

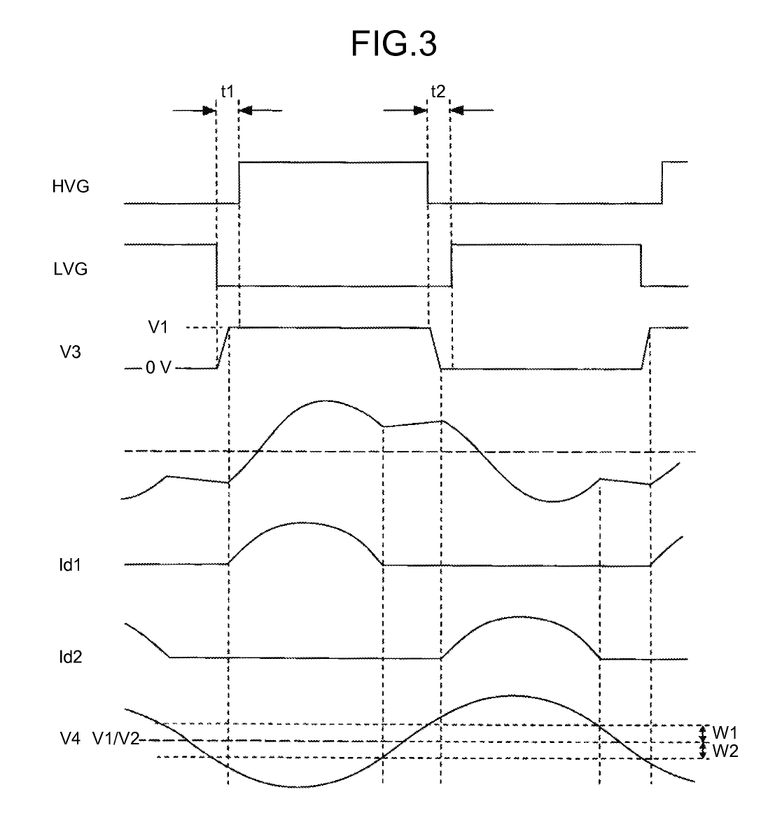

FIG. 4 is a diagram illustrating the structure of a multi-phase Alternating Current (AC)/Direct Current (DC) converter according to a first embodiment;

FIG. 5 is a diagram illustrating the structure of a multi-phase AC/DC converter according to a second embodiment;

FIG. 6 is a diagram illustrating the structure of a multi-phase AC/DC converter according to a third embodiment; and

FIG. 7 is a diagram illustrating the structure of a multi-phase AC/DC converter according to a fourth embodiment.

### BEST MODE(S) FOR CARRYING OUT THE INVENTION

### First Embodiment

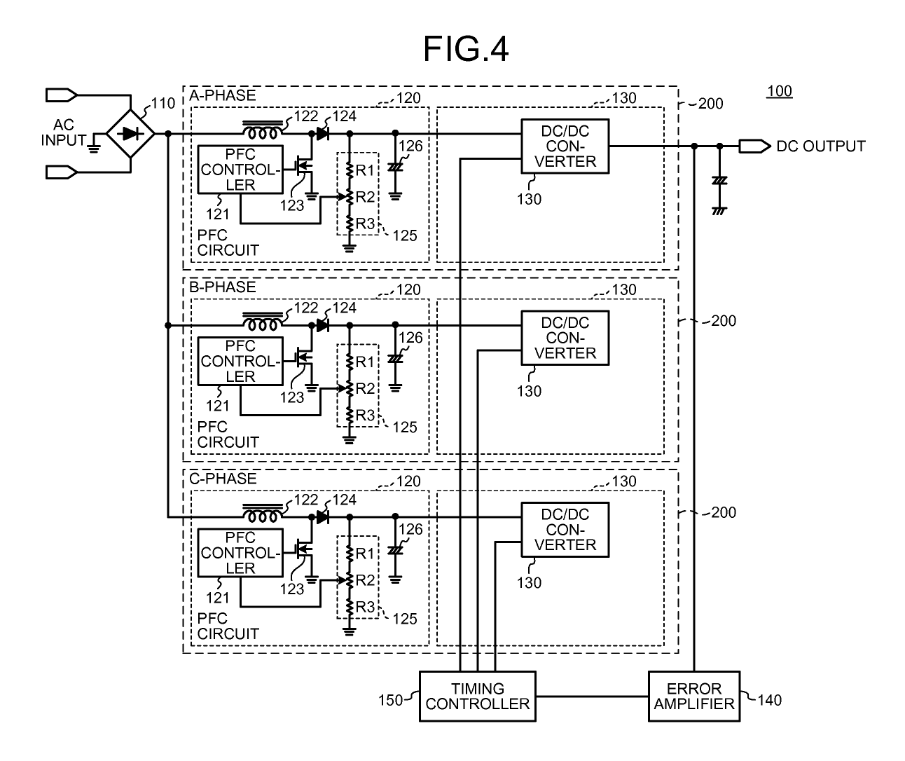

Hereinafter, a first embodiment of the invention will be described with reference to the accompanying drawings. FIG. 4 is a diagram illustrating the structure of a multi-phase Alternating Current (AC)/Direct Current (DC) converter according to the first embodiment.

A multi-phase AC/DC converter 100 according to this embodiment includes three (A-phase, B-phase, and C-phase) AC/DC converters 200 which are connected so as to obtain multiple phases. The AC/DC converter 200 is formed by combining a power factor correction circuit (PFC circuit) 120 with a DC/DC converter 130.

In this embodiment, the A-phase, B-phase, and C-phase AC/DC converters 200 have the same components. Therefore, the same components are denoted by the same reference numerals.

Next, the AC/DC converter 200 according to this embodiment will be described. The AC/DC converter 200 according to this embodiment includes the PFC circuit 120 and the DC/DC converter 130.

In the AC/DC converter 200 according to this embodiment, a voltage input from an AC power supply is full-wave rectified by a bridge diode 110 and the rectified voltage is input to the PFC circuit 120. This voltage is boosted to a predetermined DC voltage by the PFC circuit 120 and is then supplied to the DC/DC converter 130.

The DC/DC converter 130 according to this embodiment is an LLC current resonant converter. The DC/DC converter 130 converts a DC voltage output from the PFC circuit 120 which is connected in series thereto into a predetermined DC voltage and outputs the converted DC voltage. In this case, the output voltage from the DC/DC converter 130 is monitored by an error amplifier 140; and a signal corresponding to an error between the output voltage and a predetermined voltage value is transmitted to a timing controller 150. The timing controller 150 changes the operating frequency of the DC/DC converter 130 in a direction in which the error between the output voltage and the predetermined voltage value is reduced. In this case, the A-phase, B-phase, and C-phase DC/DC converters 130 have the same operating frequency and the phase difference therebetween is maintained to be constant.

Next, the PFC circuit 120 according to this embodiment will be described. The PFC circuit 120 according to this embodiment includes a PFC controller 121, a PFC coil 122, an n-channel MOSFET 123, a diode 124, an output voltage adjusting circuit 125, and an output smoothing capacitor 126.

The PFC circuit 120 according to this embodiment is controlled by the PFC controller 121. The PFC controller 121 turns on the n-channel MOSFET 123 to charge energy to the PFC coil 122 with the voltage waveform of the AC voltage which is full-wave rectified by the bridge diode 110. In addition, when the n-channel MOSFET 123 is turned off, the PFC controller 121 transmits the energy stored in the PFC coil 122 to the output smoothing capacitor 126 through the diode 124 and stores the energy in the output smoothing capacitor 126.

The output voltage adjusting circuit 125 according to this embodiment adjusts the output voltage from the PFC circuit 120. The output voltage adjusting circuit 125 according to this embodiment has a structure in which resistors R1, R2, and R3 are connected in series between a cathode of the diode 124 and the ground. The output voltage adjusting circuit 125 according to this embodiment can change the voltage division ratio of the resistors between the ground and the cathode of the diode 124 using, for example, a volume to adjust the output voltage from the PFC circuit 120.

Therefore, in this embodiment, for example, during the shipment of a switching power supply including the multi-phase AC/DC converter 100 according to this embodiment, it is possible to compensate for a variation in the outputs of the A-phase, B-phase, and C-phase DC/DC converters 130 by adjusting the output voltage using the output voltage adjusting circuit 125 in a necessary current load state.

Therefore, in the multi-phase AC/DC converter 100 according to this embodiment, the output voltages from the PFC circuits 120 of each phase are adjusted so that the DC/DC converters 130 of each phase can output substantially the same power.

### Second Embodiment

Hereinafter, a second embodiment of the invention will be described with reference to the drawings. In the second embodiment of the invention, components having the same functions and structures as those in the first embodiment are denoted by the same reference numerals as those in the first embodiment; and a description thereof will be omitted.

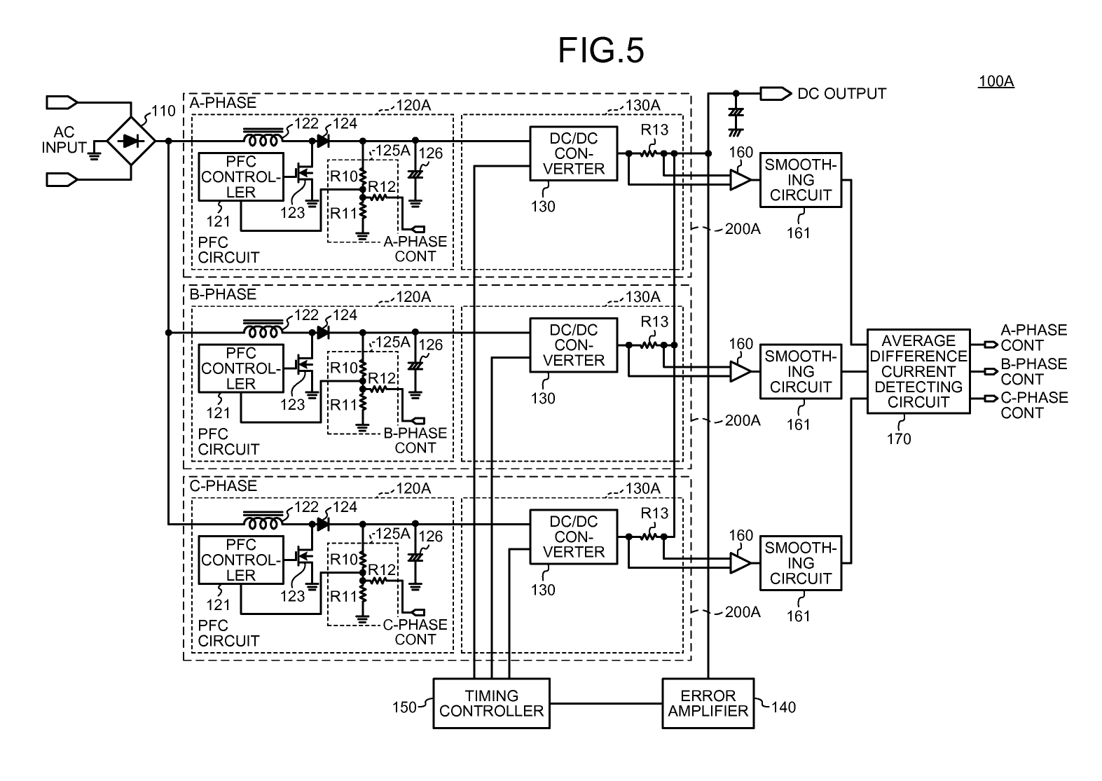

FIG. 5 is a diagram illustrating the structure of a multi-phase AC/DC converter according to the second embodiment.

A multi-phase AC/DC converter 100A according to this embodiment includes three (A-phase, B-phase, and C-phase) AC/DC converters 200A which are connected thereto so as to obtain multiple phases. The AC/DC converter 200A is formed by combining a PFC circuit 120A with a DC/DC converter 130A. Each of the A-phase, the B-phase, and the C-phase in the multi-phase AC/DC converters 100A according to this embodiment includes a fixed resistor R13, a difference amplifier 160, and a smoothing circuit 161. The outputs of the A-phase, B-phase, and C-phase smoothing circuits 161 are supplied to an average difference current detecting circuit 170. The output of the average difference current detecting circuit 170 is supplied to an output voltage adjusting circuit 125A, which will be described below.

The PFC circuit 120A according to this embodiment includes a PFC controller 121, a PFC coil 122, an n-channel MOSFET 123, a diode 124, the output voltage adjusting circuit 125A, and an output smoothing capacitor 126.

The output voltage adjusting circuit 125A includes resistors R10, R11, and R12. The resistor R10 and the resistor R11 are connected in series between the cathode of the diode 124 and the ground. One end of the resistor R12 is connected to a connection point between the resistor R10 and the resistor R11. The other end of the resistor R12 is connected to the output end of the average difference current detecting circuit 170, which will be described below.

The DC/DC converter 130A according to this embodiment includes a DC/DC converter 130 and a fixed resistor R13. One end of the fixed resistor R13 is connected to the output end of the DC/DC converter 130 and one input end of the difference amplifier 160, and the other end of the fixed resistor R13 is connected to the other input end of the difference amplifier 160. The fixed resistor R13 and the difference amplifier 160 are for detecting an output current from the DC/DC converter 130. The output of the difference amplifier 160 is supplied to the smoothing circuit 161. The smoothing circuit 161 smoothes the obtained current value.

The average difference current detecting circuit 170 calculates the average value of the output currents from the A-phase, B-phase, and C-phase smoothing circuit 161, detects a difference from the average value, and outputs a control signal. The control signal output from the average difference current detecting circuit 170 is fed back as a bias signal to one end of the resistor R12 in the output voltage adjusting circuit 125A.

When the A-phase, B-phase, and C-phase output currents are equal to each other, the average difference current detecting circuit 170 according to this embodiment outputs, as the control signal, a voltage which is equal to a reference voltage of an error amplifier (not shown) in the PFC controller 121. The output voltage from the PFC circuit 120A is determined by the voltage division ratio of the resistors in the output voltage adjusting circuit 125A.

A voltage obtained by dividing the voltage of the cathode of the diode 124 by the resistors R10 and R11 is controlled to be equal to the reference voltage of the error amplifier in the PFC controller 121, thereby making the output voltage from the PFC circuit 120A constant.

The output voltage adjusting circuit 125A according to this embodiment adds the control signal output from the average difference current detecting circuit 170 as a bias to the voltage obtained by dividing the voltage of the cathode of the diode 124 by the resistors R10 and R11 through the resistor R12. In this embodiment, the output voltage from the output voltage adjusting circuit 125A is controlled to be equal to the reference voltage of the error amplifier in the PFC controller 121. In this way, the output voltage of the PFC circuit 120A corresponds to the output of the average difference current detecting circuit 170. Then, a variation in the outputs of the A-phase, B-phase, and C-phase DC/DC converters 130 is adjusted so as to approximate a direction in which the A-phase, B-phase, and C-phase output currents are equal to each other.

According to this embodiment, the output voltages from the PFC circuits 120A of each phase are controlled by the output currents from the DC/DC converters 130A of each phase. Therefore, it is possible to make the output power levels of the DC/DC converters 130A of each phase substantially equal to each other without adjusting a circuit structure.

### Third Embodiment

Hereinafter, a third embodiment of the invention will be described with reference to the drawings. In the third embodiment of the invention, components having the same functions and structures as those in the first embodiment are denoted by the same reference numerals as those in the first embodiment and a description thereof will be omitted.

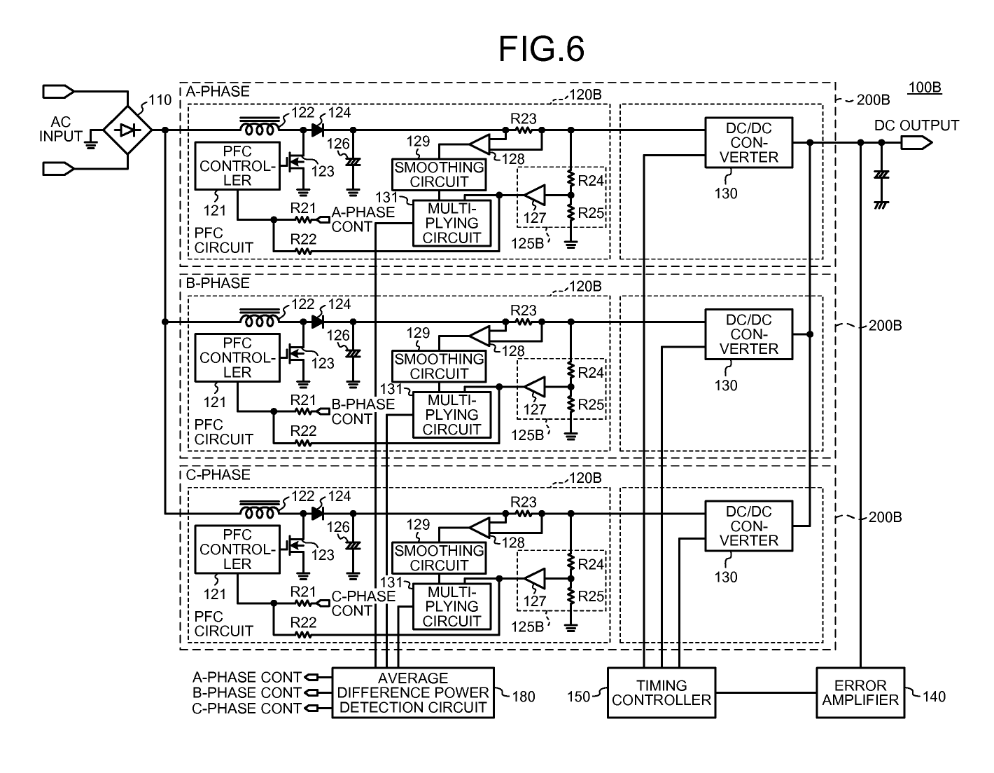

FIG. 6 is a diagram illustrating the structure of a multi-phase AC/DC converter according to the third embodiment.

A multi-phase AC/DC converter 100B according to this embodiment includes three (A-phase, B-phase, and C-phase) AC/DC converters 200B which are connected so as to obtain multiple phases. The AC/DC converter 200B is formed by combining a PFC circuit 120B and a DC/DC converter 130.

Each of the A-phase, B-phase, and C-phase PFC circuits 120B in the AC/DC converter 200B according to this embodiment includes a PFC controller 121, a PFC coil 122, an n-channel MOSFET 123, a diode 124, an output voltage adjusting circuit 125B, a difference amplifier 128, a smoothing circuit 129, a multiplying circuit 131, and fixed resistors R21, R22, and R23.

The fixed resistor R23 and a difference amplifier 158 detect an output current from the PFC circuit 120B. The smoothing circuit 129 smoothes the output of the difference amplifier 128.

The output voltage adjusting circuit 125B detects an output voltage from the PFC circuit 120B. In the output voltage adjusting circuit 125B according to this embodiment, the fixed resistors R24 and R25 are connected in series between one end of the fixed resistor R23 and the ground and a connection point between the fixed resistors R24 and R25 is connected to an input end of an amplifier 127. The output of the amplifier 127 is supplied to the multiplying circuit 131. In addition, the output of the amplifier 127 is supplied to the PFC controller 121 through the fixed resistor R22.

The multiplying circuit 131 multiplies the output current from the smoothing circuit 129 by the output voltage from the output voltage adjusting circuit 125B to calculate the output power of the PFC circuit 120B. The fixed resistors R21 and R22 synthesize the output voltage from the multiplying circuit 131 with the output voltage from the output voltage adjusting circuit 125B.

The multi-phase AC/DC converter 100B according to this embodiment includes an average difference power detecting circuit 180. The average difference power detecting circuit 180 receives the outputs of the A-phase, B-phase, and C-phase multiplying circuits 131. The average difference power detecting circuit 180 according to this embodiment calculates the average value of the output power levels of the PFC circuits 120B which are output from the multiplying circuits 131, detects a difference from the average value, and outputs a control signal.

When the output power levels of the A-phase, B-phase, and C-phase PFC circuits 120B are equal to each other, the output voltage from the average difference power detecting circuit 180 is equal to the reference voltage of an error amplifier (not shown) in the PFC controller 121. The output voltage from the PFC circuit 120B is determined by the voltage division ratio of the resistors in the output voltage adjusting circuit 125B.

In this embodiment, when the output power levels of the A-phase, B-phase, C-phase PFC circuit 120B are different from each other, the voltage shifts from the reference voltage value of the error amplifier in the PFC controller 121 according to the difference between the output power levels, thereby changing the output voltages from the PFC circuits 120B. A variation in the outputs of the A-phase, B-phase, and C-phase DC/DC converters 130 is adjusted so as to approximate a direction in which thereby the output power levels of the A-phase, B-phase, and C-phase PFC circuits 120B are equal to each other.

In this embodiment, the output voltages from the PFC circuits 120B of each phase are controlled by the output power levels of the PFC circuits 120B of each phase. Therefore, it is possible to make the output power levels of the PFC circuits 120B of each phase substantially equal to each other without any influence on the circuit structure of the DC/DC converter 130.

### Fourth Embodiment

Hereinafter, a fourth embodiment of the invention will be described with reference to the drawings. In the fourth embodiment of the invention, components having the same functions and structures as those in the first embodiment are denoted by the same reference numerals as those in the first embodiment and a description thereof will be omitted.

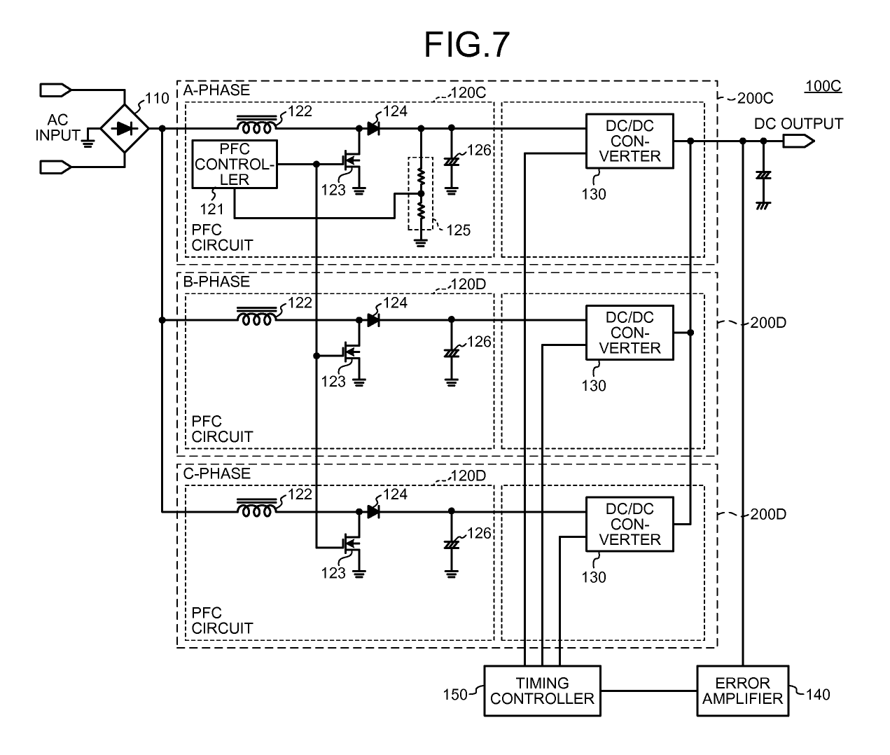

FIG. 7 is a diagram illustrating the structure of a multi-phase AC/DC converter according to the fourth embodiment.

A multi-phase AC/DC converter 100C according to this embodiment includes an A-phase AC/DC converter 200C and B-phase and C-phase AC/DC converters 200D.

In this embodiment, the AC/DC converter 200D does not include a PFC controller 121, and an n-channel MOSFET 123 of the AC/DC converter 200D is controlled by the PFC controller 121 of the AC/DC converter 200C.

The AC/DC converter 200C according to this embodiment includes a PFC circuit 120C and a DC/DC converter 130. The PFC circuit 120C includes the PFC controller 121, a PFC coil 122, an n-channel MOSFET 123, a diode 124, an output voltage adjusting circuit 125, and an output smoothing capacitor 126.

The AC/DC converter 200D according to this embodiment includes a PFC circuit 120D and a DC/DC converter 130. The PFC circuit 120D includes a PFC coil 122, an n-channel MOSFET 123, a diode 124, and an output smoothing capacitor 126.

In this embodiment, a control signal output from the PFC controller 121 of the PFC circuit 120C is supplied to the n-channel MOSFET 123 of the PFC circuit 120C and the n-channel MOSFET 123 of the PFC circuit 120D. Therefore, in this embodiment, for each phase, the n-channel MOSFETs 123 are turned on or off by the same control signal and have the same switching frequency.

In this embodiment, the DC voltage of the A-phase PFC circuit 120C is maintained to be constant by a signal from the output voltage adjusting circuit 125. In this embodiment, since the B-phase and C-phase PFC circuits 120D are controlled by the switching timing of the A-phase PFC circuit 120C, the B-phase and C-phase output voltages are variable. However, the output power levels of the A-phase, B-phase, and C-phase PFC circuits 120C and 120D are substantially equal to each other since the PFC circuits have the same switching timing. Therefore, when there is a variation in the output of each DC/DC converter 130, the output voltages from the B-phase and C-phase PFC circuits 120D are changed to compensate for the variation in the outputs of the A-phase, B-phase, and C-phase DC/DC converters 130.

As described above, in this embodiment, since the PFC circuits of each phase are configured so as to have the same switching frequency, the DC/DC converters 130 of each phase can have substantially the same output power. Therefore, it is possible to simplify a circuit structure.

According to the invention, it is possible to maximize the function of the multi-phase converter without impairing the output power capacity of each LLC current resonant converter even when multiple phases are obtained.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

1. A multi-phase converter comprising:
a plurality of AC/DC converters which are connected in parallel to each other,
wherein
each of the plurality of AC/DC converters includes
a power factor correction circuit and
a DC/DC converter
that is connected in series to the power factor correction circuit and
that receives an output from the power factor correction circuit, and
the power factor correction circuit includes
an output voltage adjusting circuit that adjusts an output voltage from the power factor correction circuit.

2. The multi-phase converter according to claim 1, further comprising:
a DC/DC converter output current detecting circuit that detects an output current from the DC/DC converter included in each of the plurality of AC/DC converters; and
an average difference current detecting circuit that feeds back a control signal corresponding to a difference from an average value of the output currents detected by the DC/DC converter output current detecting circuit to the output voltage adjusting circuit,
wherein the output voltage adjusting circuit adjusts the output voltage from the power factor correction circuit on a basis of the control signal that is fed back from the average difference current detecting circuit.

3. The multi-phase converter according to claim 1, further comprising:
a power factor correction circuit output current detecting circuit that detects an output current from the power factor correction circuit included in each of the plurality of AC/DC converters;
a power factor correction circuit output voltage detecting circuit that detects the output voltage from the power factor correction circuit included in each of the plurality of AC/DC converters;
a multiplying circuit that multiplies the output current by the output voltage to calculate the output power of each of the plurality of AC/DC converters; and
an average difference power detecting circuit that feeds back a control signal corresponding to a difference from an average value of the output power levels of the plurality of AC/DC converters to the output voltage adjusting circuit,
wherein the output voltage adjusting circuit adjusts the output voltage from the power factor correction circuit on a basis of the control signal that is fed back from the average difference power detecting circuit.

4. The multi-phase converter according to claim 1,
wherein the power factor correction circuit in each of the plurality of AC/DC converters includes a switching element, and
the switching elements are turned on/off at the same switching frequency by a control signal output from a controller that is provided in one of the power factor correction circuits of the plurality of AC/DC converters and controls the power factor correction circuit.
